(19) United States
(12) Patent Application Publication
(10) Pub. No.: US 2026/0260001 A1
(43) Pub. Date: Sep. 3, 2026

(54) PRIVACY PRESERVING COMPUTATION VIA SHUFFLING

(71) Applicant: Guangzhou University, Guangzhou (CN)

(72) Inventors: Shaowei Wang, Guangzhou (CN); Jin Li, Guangzhou (CN); Meiting Hou, Guangzhou (CN); Changyu Dong, Guangzhou (CN); Jin Li, Guangzhou (CN); Yun Peng, Guangzhou (CN)

(21) Appl. No.: 19/437,165

(22) Filed: Dec. 30, 2025

(30) Foreign Application Priority Data
Mar. 3, 2025 (CN) 202510240902.0

(51) Int. Cl. G06F 21/60; G06F 21/62

(52) U.S. Cl. CPC G06F 21/602; G06F 21/6245

(57) ABSTRACT

The present invention discloses a differentially private computation method based on a shuffle model, belonging to the field of data security and personal information protection. The method comprises: constructing a personalized shuffle model; optimizing the data randomization performance of the personalized shuffle model by using a randomization mechanism optimized for non-statistical tasks to obtain an improved personalized shuffle model; and using the improved personalized shuffle model to perform encryption and decryption on user input data. The invention enables personalized outputs while maintaining privacy and benefiting from the privacy amplification effect of the shuffle model. Through an innovative combination of encryption and anonymization, the invention addresses the long-standing challenges of privacy protection in non-statistical tasks and demonstrates broad applicability. Furthermore, by optimizing the utility-privacy trade-off in the randomization process, the invention significantly enhances privacy protection strength and the accuracy of personalized computation, even when the number of participating users is limited.

### TECHNICAL FIELD

The present invention relates to the field of data security and personal information protection, and more particularly to a differentially private computation method based on a shuffle model.

### BACKGROUND

Differential privacy is a technique for protecting the privacy of individual data by adding random noise to the data, thereby preventing the disclosure of personal information. It ensures that the distribution of analysis results remains almost unchanged regardless of whether the data of any individual is included, thus protecting each participant's privacy.

Differential privacy can be divided into central differential privacy (CDP) and local differential privacy (LDP). In the central model, users send their data to a trusted centralized server, which processes the data and adds noise to the results to ensure privacy protection. This model requires users to place complete trust in the server and is therefore unsuitable for decentralized environments. In the local model, users randomize their data locally before sending it to the server, thereby removing the need for a trusted centralized curator. However, this approach often leads to a significant loss of utility, since each user perturbs their data independently.

The shuffle model is a new paradigm that lies between central and local differential privacy. In this model, client data are shuffled by an independent shuffler before being sent to the server, making it difficult to trace the data back to its source and thereby enhancing privacy protection. This model provides better utility than local differential privacy while reducing dependence on a trusted central server.

Nevertheless, the shuffle model has a notable limitation. Its privacy amplification effect depends heavily on the anonymized and shuffled messages, which greatly restricts the types of computations that can be performed. So far, the only computations that can be achieved under the shuffle model are statistical estimations, in which the server aggregates the shuffled messages to produce a single global output, such as a count, sum, or histogram. However, many real-world applications are inherently non-statistical, where multiple users jointly perform a computation and expect personalized outputs that may differ among participants. Addressing this issue and extending the shuffle model to support a wider range of non-statistical and permutation-equivariant tasks while preserving differential privacy has therefore become an urgent and significant technical challenge.

### SUMMARY OF THE INVENTION

To address the problems existing in related technologies, the present invention proposes a differential privacy computation method based on a shuffle model, in order to overcome the technical limitations of the prior art.

To this end, the specific technical solution adopted by the invention is as follows: A differential privacy computation method based on a shuffle model, comprising the following steps:
S1. Constructing a personalized shuffle model; optimizing the data randomization performance of the personalized shuffle model by using a randomization mechanism optimized for non-statistical tasks to obtain an improved personalized shuffle model;
S2. Using the improved personalized shuffle model to perform encryption and decryption operations on users' input data.

Further, constructing the personalized shuffle model comprises: expanding the application scope of the shuffle model so that it supports personalized outputs rather than being limited to statistical estimation; and making the shuffle model independent of the randomizer.

Further, optimizing the data randomization performance of the personalized shuffle model by using a randomization mechanism optimized for non-statistical or permutation-equivariant tasks to obtain an improved personalized shuffle model comprises: configuring the input domain and output domain of the randomization mechanism optimized for non-statistical or permutation-equivariant tasks; using the randomization mechanism optimized for non-statistical or permutation-equivariant tasks to select a first randomized value with a first probability and a second randomized value with a second probability; and integrating the configured randomization mechanism into the personalized shuffle model to obtain the improved personalized shuffle model.

Further, configuring the input domain and output domain of the randomization mechanism optimized for non-statistical or permutation-equivariant tasks comprises: setting both the input domain and output domain as spherical regions, wherein the radius of the output domain is greater than that of the input domain by a number of Minkowski distances.

Further, using the randomization mechanism optimized for non-statistical or permutation-equivariant tasks to select a first randomized value with a first probability and a second randomized value with a second probability comprises: determining a selection range based on a true value, wherein the first randomized value is located within the selection range of the true value; selecting the second randomized value from outside the selection range of the true value; and ensuring that the first probability is greater than the second probability.

Further, using the improved personalized shuffle model to perform encryption and decryption of user input data comprises: each user adding noise to their input data and encapsulating it into a public-key encrypted message under the computation server's public key; applying the improved personalized shuffle model to shuffle the public-key encrypted messages and sending the shuffled results to the computation server; decrypting the shuffled public-key encrypted messages at the computation server and performing a permutation-equivariant computation on the decrypted data; outputting the results of the permutation-equivariant computation through the computation server; and each user decrypting the entry associated with their own public key from the results of the permutation-equivariant computation.

Further, the public-key encrypted message comprises the user's input data, the noise added by the user, and the public key.

Further, the public key is configured to allow the computation server to encrypt the results of the permutation-equivariant computation and to serve as a pseudonymous identifier of the key owner.

Further, shuffling the public-key encrypted messages using the improved personalized shuffle model comprises: performing data permutation and message shuffling on the public-key encrypted messages using the improved personalized shuffle model; and encrypting the user's input data with the computation server's public key.

Further, outputting the results of the permutation-equivariant computation through the computation server comprises: listing the results of the permutation-equivariant computation as pairs of each user's public key and the corresponding encrypted computation result.

The advantageous effects of the present invention are as follows:
1. PIC Model: Through an innovative encryption and anonymization scheme, the invention addresses key challenges in privacy protection for non-statistical tasks and demonstrates broad application potential. The PIC model extends the application scope of the shuffle model, enabling personalized outputs rather than being restricted to statistical estimation.
2. Minkowski Randomizer: The proposed Minkowski randomizer optimizes the utility-privacy trade-off, significantly improving both the strength of privacy protection and the accuracy of personalized computation, even when the number of users is limited. The Minkowski randomizer provides a randomization mechanism optimized for non-statistical tasks, achieving a balance between privacy protection and utility.
3. Enhanced Privacy Protection: By introducing shuffling techniques, the invention increases data randomness, making it difficult for attackers to infer individual information from input-output relationships, thereby effectively enhancing data privacy protection.
4. Improved Computational Efficiency: While ensuring privacy protection, the proposed method optimizes the computation process, reduces computational complexity, and improves data processing efficiency, showing excellent performance especially in large-scale data processing scenarios.
5. Wide Applicability: The invention introduces a new paradigm called Private Individual Computation (PIC), which extends the shuffle model of differential privacy to support a wider range of permutation-equivariant computations, rather than being limited to statistical estimation. This is important because many real-world applications require personalized outputs for each user rather than a single aggregated output, as is typical in statistical estimation tasks.

### BRIEF DESCRIPTION OF THE DRAWINGS

In order to more clearly illustrate the technical solutions of the embodiments of the present invention or of the related art, the drawings required for describing the embodiments are briefly introduced below. It should be understood that the drawings described below merely show some embodiments of the present invention, and for those skilled in the art, other drawings can be obtained based on these drawings without creative efforts.

FIG. 1 is a flow diagram illustrating a differential privacy computation method based on a shuffle model according to an embodiment of the present invention.

### DETAILED DESCRIPTION OF THE INVENTION

To further illustrate the embodiments, the present invention is accompanied by drawings that form part of the disclosure. These drawings are primarily intended to illustrate the embodiments and, together with the relevant descriptions in the specification, to explain the operating principles of the embodiments. It should be understood that the drawings described below merely illustrate some embodiments of the present invention, and that other drawings may be obtained by those skilled in the art based on these drawings without the exercise of inventive effort. The components shown in the drawings are not necessarily drawn to scale, and like reference numerals generally denote like components.

According to an embodiment of the present invention, a differential privacy computation method based on a shuffle model is provided.

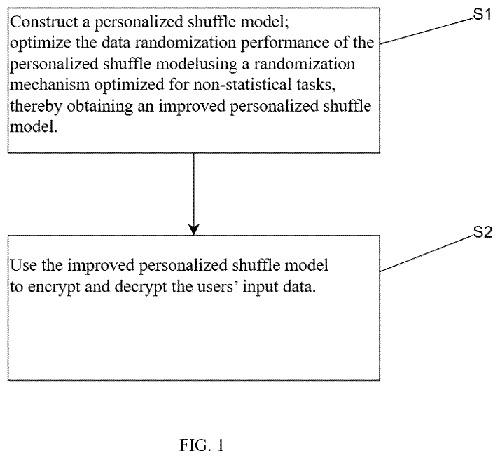

The invention is further described below with reference to the accompanying drawings and specific embodiments. As shown in FIG. 1, according to an embodiment of the present invention, the differential privacy computation method based on a shuffle model comprises:
S1. Constructing a personalized shuffle model; optimizing the data-randomization performance of the personalized shuffle model by using a randomization mechanism optimized for non-statistical tasks to obtain an improved personalized shuffle model.
S2. Using the improved personalized shuffle model to perform encryption and decryption of users' input data.

In one embodiment, constructing the personalized shuffle model comprises: expanding the application scope of the shuffle model so that it supports personalized outputs rather than being limited to statistical estimation; and making the shuffle model independent of the randomizer.

In one embodiment, optimizing the data-randomization performance of the personalized shuffle model by using a randomization mechanism optimized for non-statistical tasks to obtain an improved personalized shuffle model comprises: configuring the input domain and the output domain of the randomization mechanism optimized for non-statistical tasks; and using that mechanism to select a first randomized value with a first probability and a second randomized value with a second probability. The configured randomization mechanism optimized for non-statistical tasks is then incorporated into the personalized shuffle model to obtain the improved personalized shuffle model.

In one embodiment, configuring the input domain and the output domain of the randomization mechanism optimized for non-statistical tasks comprises: defining both the input domain and the output domain as spherical regions, wherein the radius of the output domain is larger than the radius of the input domain by a number of Minkowski distances.

In one embodiment, using the randomization mechanism optimized for non-statistical tasks to select a first randomized value with a first probability and a second randomized value with a second probability comprises: determining a selection range based on the true value, wherein the first randomized value lies within the selection range of the true value; selecting the second randomized value from outside the selection range of the true value; wherein the first probability is greater than the second probability.

In one embodiment, using the improved personalized shuffle model to perform encryption and decryption of users' input data comprises: each user adding noise to their input data and encapsulating it into a public-key-encrypted message under the computation server's public key; the improved personalized shuffle model performing a shuffle over the public-key-encrypted messages and sending the shuffled results to the computation server; the computation server decrypting the shuffled public-key-encrypted messages and performing a permutation-equivariant computation on the decrypted data; the computation server outputting the results of the permutation-equivariant computation; and each user decrypting the entry associated with their own public key from the computation results.

In one embodiment, the public-key-encrypted message comprises the user's input data, the noise added by the user, and the public key.

In one embodiment, the public key is configured to allow the computation server to encrypt the results of the permutation-equivariant computation and serves as an anonymous identifier of the key owner.

In one embodiment, performing shuffling on the public-key-encrypted messages using the improved personalized shuffle model comprises: applying data permutation and message shuffling to the public-key-encrypted messages using the improved personalized shuffle model; and encrypting each user's input data with the computation server's public key.

In one embodiment, outputting the results of the permutation-equivariant computation through the computation server comprises: listing the results as pairs of each user's public key and the corresponding encrypted computation result.

To facilitate understanding of the above technical solutions, the working principles of the invention in practical operation are described in detail below.

The PIC model and the Minkowski randomizer proposed in this invention address different technical challenges. The PIC model extends the application scope of the shuffle model to support personalized outputs rather than being restricted to statistical estimation. The Minkowski randomizer provides a randomization mechanism optimized for non-statistical tasks, thereby achieving a trade-off between privacy protection and utility.

The present invention aims to explore the applicability of the shuffle model to non-statistical private computation tasks, particularly those that existing methods struggle to handle effectively, such as spatial crowdsourcing, ad allocation, combinatorial optimization, location-based social systems, and incentive-driven federated learning. By introducing new technical means such as randomized keys and noise addition, the invention enables efficient and high-utility data processing and computation while protecting user privacy.

The present invention proposes a privacy-preserving computation framework based on the shuffle model. The Private Individual Computation (PIC) model enables personalized outputs while preserving user privacy and achieves privacy amplification through shuffling. A concrete PIC protocol is provided to implement the proposed method.

By employing one-time public keys, the protocol allows users to obtain their individual outputs without compromising anonymity, which is a key factor in achieving privacy amplification.

Furthermore, an optimal randomizer, referred to as the Minkowski Response, is designed for the PIC model to enhance computational utility. The security and privacy properties of the PIC protocol are formally proven. Both theoretical analysis and experimental evaluations demonstrate that the PIC framework effectively handles non-statistical computation tasks and that the PIC protocol and Minkowski randomizer achieve superior utility compared with existing approaches.

The main inventive features of the present invention include:

### PIC Protocol

The PIC model serves as a general framework for privacy amplification, designed independently of any specific randomizer. Therefore, it can support the Minkowski randomizer as well as other randomization mechanisms.
1. Each user adds noise to their data and encapsulates it, together with a one-time public key, into a message encrypted under the computation server's public key.
2. The shuffler performs shuffling on the encrypted messages and forwards them to the computation server.
3. The computation server decrypts the shuffled messages and performs a permutation-equivariant computation.
4. The computation server publishes the computation results, each encrypted under the corresponding user's one-time public key.
5. Each user downloads the published list and decrypts the entry associated with their own public key, thereby preserving anonymity. Users may also establish secure communication channels with other matched participants using their public keys to complete PIC tasks.

### Minkowski Response

The Minkowski randomizer represents an independent technical innovation proposed in the present invention. It is designed to optimize the data randomization performance within the PIC model; however, its algorithmic structure can be adapted to a broader range of privacy-preserving computation tasks. Therefore, the randomizer can be used independently or in combination with other privacy-preserving models, demonstrating high versatility and innovativeness.

A randomization mechanism is provided for personalized computation tasks, the mechanism comprising the following steps:
1. The output domain of the randomizer is defined as a sphere whose radius is larger than that of the input domain by r Minkowski distances, where r is determined by the privacy budget.
2. The randomizer selects a value close to the true value (within r) with a relatively higher probability, and selects a value from outside this range with a relatively lower probability, in order to achieve high utility.
3. The invention proves that the error upper bound of the Minkowski Response matches the error lower bound of all possible randomizers in the PIC model, thereby achieving asymptotic optimality.
4. Compared with existing Local Differential Privacy (LDP) randomizers used in the PIC model, the Minkowski randomizer provides significantly better utility, and this advantage remains evident even when the number of users is not large (around the order of 10²).

The PIC method includes:

Parameters: m∈N, groups G₁, G₂, . . . , Gₘ, where nᵢ=|Gᵢ| represents the number of users in group Gᵢ; the data randomization mechanism for group Gᵢ is Rᵢ; and the server is denoted as S. Function: Accepts all users' n=Σ_{i∈[m]} nᵢ inputs [{x_{i,j}}_{i∈[m]]j∈[|G}_{ᵢ}_{|]}], along with the description of a function ƒ to be computed on the server, and performs the following steps:
1. For all i∈[m] and j∈[|Gᵢ|], compute

$${x}_{i , j}^{′} ← {R}_{i} ( {x}_{i} , j )$$

2. Sample m random permutations π₁, π₂, . . . , πₘ, where πᵢ: |nᵢ|→|nᵢ|, shuffle the inputs, and obtain

$$L = \{ {x}_{1 , {π}_{1} ( j )}^{′} , j ∈ [ {n}_{1} ] , … , {x}_{m , {π}_{m} ( j )}^{′} , j ∈ [ {n}_{m} ] \}$$

then compute (y_{1,π}_{₁}₍ⱼ₎, j∈[n₁], . . . y_{m,π}_{ₘ}₍ⱼ₎, j∈[nₘ]←f(L)).
3. Send y_{i,π}_{ᵢ}₍ⱼ₎ to user u_{i,j} for all i∈[m] and j∈[nᵢ]. Additionally, send L and ƒ(L) to the server S. Here, m∈N represents the number of user groups G₁, G₂, . . . , Gₘ; nᵢ=|Gᵢ| denotes that there are nᵢ users in the i-th user group Gᵢ; Rᵢ denotes the data randomization mechanism used for group Gᵢ; and S denotes the server. [{x_{i,j}}_{i∈[m],j∈[|G}_{ᵢ}_{|]}] represents the input data provided by all users, where x_{i,j} is the input data of the j-th user in group i. ƒ is the function computed on the server.

$${x}_{i , j}^{′} ← {R}_{i} ( {x}_{i , j} )$$

denotes' the privacy-preserving data obtained by randomizing the user's input through the mechanism Rᵢ. π₁, π₂, . . . , πₘ denote random permutations applied to the user groups.

$$L = \{ {x}_{1 , {π}_{1} ( j )}^{′} , j ∈ [ {n}_{1} ] , … , {x}_{m , {π}_{m} ( j )}^{′} , j ∈ [ {n}_{m} ] \}$$

represents the shuffled list of privacy-preserving data. {y_{1,π}_{₁}₍ⱼ₎, j∈[n₁], . . . , y_{m,π}_{ₘ}₍ⱼ₎, j∈[nₘ]←f(L)} represents the output computed from the shuffled list L. y_{i,π}_{ᵢ}₍ⱼ₎ denotes the message corresponding to the j-th user u_{i,j} in group i, which is obtained by applying the randomizer R_{i,j} to the user's input x″_{i,j} and then reordering the resulting ciphertexts according to a random permutation πᵢ.[L, ƒ(L)] indicates that both the intermediate shuffled data L and the final output ƒ(L) are sent to the server S.

The Shuffle method includes:

Parameters: n∈N: a natural number. Participants P₁, P₂, . . . , Pₙ. A server S. A set of corrupted parties C. The leakage L(π)=[i, π(i)], i∈C represents the permutation information revealed to corrupted parties.

Method: After receiving n inputs {xᵢ}_{i∈[n]} from P₁, P₂, . . . , Pₙ:

Sample a random permutation π∈Sₙ, where Sₙ denotes a random permutation operator that randomly permutes messages y₁, y₂, . . . , yₙ from the n users. Specifically, Sₙ is a function S:Yⁿ→Yⁿ that applies a random permutation to the n input messages, generating a newly permuted sequence.

Define {yᵢ}_{i∈[n]} such that yᵢ=x_{π(i)}.

Send {yᵢ}_{i∈[n]} to the server S. If S∈C, then send L(π) to the adversarial server S.

Here, n∈N represents the number of participants P₁, P₂, . . . , Pₙ; S represents the server; C represents the set of corrupted parties; L(π)=[i, π(i)], i∈C denotes the permutation mapping known to the corrupted server; {xᵢ}_{i∈[n]} represents the input data of each participant; π∈Sₙ denotes the random permutation applied to the n inputs; {yᵢ}_{i∈[n]} represents the permuted output sequence where yᵢ=x_{π(i)}; yᵢ denotes the message corresponding to user i, which is obtained by applying the local randomizer R to the user's input yᵢ=R(xᵢ). x_{π(i)} denotes the message obtained after being permuted by the shuffler SSS, where w is a random permutation function.

Finally, this functionality describes a simple data obfuscation process: the participants provide their input data, the data are shuffled using a random permutation, and the shuffled data are sent to the server. If the server is corrupted, a portion of the permutation information L(π) is leaked to the server.

The encrypted data processing steps of the PIC method are as follows:

Each participant adds noise to their data and sends the encrypted message to the server.

The server performs shuffling on the encrypted data.

The server computes the function ƒ over the shuffled and sanitized user inputs, generating personalized outputs for each user.

The server publishes the computation results on a public bulletin board as pairs of one-time public keys and encrypted outputs.

Each user downloads the list from the bulletin board, locates the entry corresponding to their public key, and decrypts it to obtain their personalized computation result.

Specification of the Public-Key Encryption Scheme:

π=(Gen,Enc,Dec), where: Gen: key generation algorithm, used to generate public/private key pairs.

Enc: encryption algorithm, used to encrypt a message under a public key.

Dec: decryption algorithm, used to decrypt a message under a private key.

The security parameter (A) determines the system's security level and key length.

pk_{c}: the public key generated by the server.

User groups Gᵢ (i∈[m]): the i-th user group, where i ranges from 1 to m.

Key pairs (pk_{i,j}, sk_{i,j})←Gen(λ): each user generates a public/private key pair.

Input data x_{i,j}: the private input of the j-th user in group i.

Randomization mechanism Rᵢ: the data randomization mechanism for group i.

Perturbed data

$${x}_{i , j}^{′} ← {R}_{i} ( {x}_{i , j} )$$

represents the randomized data of user u_{i,j}.

Encrypted message

$${x}_{i , j}^{″} ← {Enc}_{pkc} ( {pk}_{i , j} \vert {x}_{i , j}^{′} ) :$$

represents the randomized data

$${x}_{i , j}^{′}$$

and the user's public key pk_{i,j} encrypted under the server's public key pk_{c}.

Shuffling function F_{Shuffle}: the function used to permute messages.

Permutation π: the random permutation applied to the data.

List L: the list of all decrypted groups on the server.

Computation function ƒ: the function computed on the decrypted list.

One possible implementation in practice:
1. Server publishes global parameters: (1) Public-key encryption scheme Π=(Gen,Enc,Dec); (2) Security parameter λ; (3) The server's public key pk_{c} generated by invoking Gen(λ); (4) For each user group (Gᵢ(i∈[m]), the corresponding data randomization mechanism Rᵢ.
2. User key generation: Let u_{i,j} denote the j-th user in group Gᵢ Each user generates a key pair (pk_{i,j},sk_{i,j})←Gen(λ), and then randomizes their private data x_{i,j} using the mechanism F_{Shuffle}. n∈N; server S; corrupted party set C; for the permutation π, leakage L(π)=[i, π(i)], i∈C.
3. Data shuffling and encryption: The function F_{Shuffle} receives all users' perturbed data zᵢ and performs random shuffling. Define {yᵢ}_{i∈[n]} such that yᵢ=x_{π(i)}, and send {yᵢ}_{i∈[n]} to the server S. If S∈C, send L(π) to the adversarial server. F_{Shuffle}Rᵢ to obtain x′_{i,j}←Rᵢ(x_{i,j}). The sanitized input is concatenated with the user's public key and encrypted using the server's public key: x″_{i,j}←Encₚₖ_{_{c}}(pk_{i,j}|x′_{i,j}).
4. Message shuffling:
   Sample a random permutation function π. Define yᵢ as the shuffled output.
   Send the shuffled messages yᵢ to the server S. If S is corrupted, send the permutation π to the adversary.
   This random shuffling enhances privacy protection since the server cannot link messages to users, while providing anonymized inputs for computation.
5. Server processing:
   The server decrypts each shuffled message and obtains lists L for all m groups as follows:

$$L = ( {\{ {p}_{k 1 , {π}_{1} ( j )} ‖ {x}_{1 , {π}_{1} ( j )}^{′} \}}_{j ∈ [ {n}_{1} ]} , … , {\{ {p}_{km , {π}_{m} ( j )} ‖ {x}_{m , {π}_{m} ( j )}^{′} \}}_{j ∈ [ {n}_{m} ]} ) .$$

The server then computes the function ƒ over L, generating outputs for each anonymous user: ({y_{1,π}_{₁}₍ⱼ₎}_{j∈[n}_{₁}_{]}, . . . , {y_{m,π}_{ₘ}₍ⱼ₎}_{j∈[n}_{ₘ}_{]})←f(L). In ({p_{k1,π}_{₁}₍ⱼ₎∥x′_{1,π}_{₁}₍ⱼ₎}_{j∈[n}_{₁}_{]}, . . . , {p_{km,π}_{ₘ}₍ⱼ₎∥x′_{m,π}_{ₘ}₍ⱼ₎}_{j∈[n}_{ₘ}_{]}), p_{k1,π}_{₁}₍ⱼ₎ denotes the public key of the j-th user in the first group, and x′_{1,π}_{₁}₍ⱼ₎ denotes the sanitized private data of the j-th user in the first group after local randomization. n₁ represents the number of users in the first group. Similarly, pₖ_{ₘ}_{,π}_{ₘ}₍ⱼ₎ denotes the public key of the j-th user in the m-th group, and x′_{m,π}_{ₘ}₍ⱼ₎ denotes the sanitized private data of the j-th user in the m-th group after local randomization. nₘ represents the number of users in the m-th group.
Each user also includes a one-time public key in the encrypted message, which serves two purposes: allowing the server to encrypt outputs for the correct recipient, and acting as an anonymous identifier for the key owner.
6. Result publication:
   The server publishes the computation results as a list on the public bulletin board: {(pₖ_{_{i,πi}}₍ⱼ₎, πᵢ(j), Enc_{Pk}_{_{i,πi}}₍ⱼ₎(y_{i,πi(j)}))}_{j∈[ni]}. Each entry consists of a public key and its corresponding encrypted computation result. In {(pₖ_{_{i,πi}}₍ⱼ₎, πᵢ(j), Enc_{Pk}_{_{i,πi}}₍ⱼ₎(y_{i,πi(j)}))}_{j∈[ni]} pₖ_{ᵢ}_{,π}_{ᵢ}₍ⱼ₎ denotes the public key of the j-th user in the i-th group; πᵢ(j) denotes the position of the j-th user in the i-th group within the random permutation π. Enc_{Pk}_{_{i,πi}}₍ⱼ₎(y_{i,πi(j)}) denotes the encryption of the computation result y_{i,π}_{ᵢ}₍ⱼ₎ under the public key pₖ_{ᵢ}_{,π}_{ᵢ}₍ⱼ₎ of the j-th user in the i-th group; and nᵢ represents the number of users in the i-th group.
7. User decryption:
   Each user downloads the entire list and decrypts the entry associated with their own public key, maintaining anonymity. Users can also use their public keys to establish secure communication channels with other matched parties to complete the PIC task.

### Implementation Example II

The PIC is instantiated with a list of parties that are compromised and colluding with the server. For each of these parties, the adversary is assumed to know the correspondence between messages before and after shuffling. As a result, the shuffle mechanism is configured to reveal that portion of the permutation to the adversary.
1. The computation server publishes the global parameters, including:
   (1) the specification of the public-key encryption schemeΠ=(Gen, Enc, Dec); (2) the security parameter λ; (3) its own public key pkₑ generated by invoking Gen(λ); and(4) for each user group Gᵢ∈[m], the data randomization mechanism Rᵢ.
2. Let the j-th user in group Gᵢ be denoted as u_{,j}. Each user generates a key pair (pkᵢ, j, skᵢ, j)←Gen(λ). Then each user randomizes their private data x_{i,j} using the mechanism function F_{Shuffle} parameterized by the group-specific randomizer Rᵢ.
   Let n∈N denote the total number of users, consisting of parties P₁, P₂, . . . , Pₙ; let S be the server and C the set of corrupted parties. For the permutation π used, the leakage is L(π)={[i, π(i)]: i∈C}. Functionality: upon receiving n inputs xᵢ from parties P₁, P₂, . . . , Pₙ with i∈[n],sample a random permutation π∈Sₙ. Define yᵢ=x_{π(i)} for i∈[n],and send all yᵢ to the server S. If S∈C, then send L(π) to the adversary.
   The function F_{Shuffle} invokes Rᵢ and obtains

$${x}_{i , j}^{′} ← {R}_{i} ( {x}_{i} , j ) .$$

Then the sanitized input is concatenated with the user's public key and encrypted under the server's public key:
3.

$${x}_{i , j}^{″} ← {Enc}_{pkc} ( {pk}_{i , j} \vert {x}_{i , j}^{′} ) ,$$

where Rᵢ represents the local randomizer used by users in group i.
   Each user in group Gᵢ invokes F_{Shuffle} on their encrypted message x″_{i,j}; F_{Shuffle} outputs the shuffled messages {x″_{i,π}_{ᵢ}₍ⱼ₎}_{j∈[n}_{ᵢ}_{]}←S({x″_{i,j}}_{j∈[n}_{ᵢ}_{]}) to the server, where πᵢ⁻¹ is the (secret) random permutation used by F_{Shuffle} within group Gᵢ.
4. The server decrypts each group of shuffled messages and obtains a list L for all m groups:

$$L = ( {\{ {p}_{{k}_{1} , {π}_{1} ( j )} ‖ {x}_{1 , {π}_{1} ( j )}^{′} \}}_{j ∈ [ {n}_{1} ]} , … , {\{ {p}_{{k}_{m} , {π}_{m} ( j )} ‖ {x}_{m , {π}_{m} ( j )}^{′} \}}_{j ∈ [ {n}_{m} ]} ) .$$

The server then computes a function ƒ on L to produce outputs for each anonymous user: ({y_{1,π}_{ᵢ}₍ⱼ₎}_{j∈[n}_{₁}_{]}, . . . , {y_{m,π}_{ₘ}₍ⱼ₎}_{j∈[n}_{ₘ}_{]})←ƒ(L).
5. The server publishes the computation results as pairs on a public bulletin board: {(pkᵢ,πᵢ(j),Encₚₖ_{ᵢ}_{,π}_{ᵢ}₍ⱼ₎(y_{i,π}_{ᵢ}₍ⱼ₎))}_{j∈[n}_{ᵢ}_{]}, i∈[m], where i denotes a user group, j denotes a user within that group, m is the number of groups, and nᵢ is the number of users in group i. πᵢ(j) is a random permutation function that shuffles user order to ensure privacy; pkᵢ, πᵢ(j) is the user's public key, used to encrypt the data while remaining bound to the user after shuffling; y_{i,π}_{ᵢ}₍ⱼ₎ is the personalized computation result generated by the server for that user; and Enc_{Pk}_{_{i,πi}}₍ⱼ₎(y_{i,πi(j)}) is the encrypted computation result.
   Each user also includes a one-time public key in the encrypted message. The one-time public key serves two purposes: it allows the server to encrypt the computation result such that only the owner of the corresponding private key can decrypt it, and it acts as an anonymous identifier for the key owner.
6. The server publishes a list where each entry consists of a public key and the computation result encrypted under that key.
7. Each user downloads the list, locates the entry associated with their own public key, and decrypts the payload to obtain their computation result.
8. Users may also use their public keys to establish secure communication channels with other matched parties, thus completing the PIC task.

Traditional differential privacy techniques are vulnerable to adversarial inference and analysis during data processing and computation, making it difficult to effectively protect user privacy. In addition, existing differential privacy models often exhibit high computational complexity and low efficiency when handling large-scale data.

The present invention provides a differential privacy computation method based on the shuffle model (PIC). By introducing a shuffling operation during data processing, the method effectively increases the randomness and unpredictability of the data, thereby enhancing the privacy protection of the data.

Compared with existing shuffle models, the key advantage of the Private Individual Computation (PIC) framework lies in its ability to support a broader range of permutation-equivariant computations that require personalized outputs for each user, while still benefiting from the privacy amplification effect provided by shuffling. This makes PIC a valuable tool for various real-world applications involving personal data processing.

The advantages of the present invention are summarized as follows:
1. PIC Model: Through an innovative integration of encryption and anonymization techniques, the invention addresses the long-standing privacy challenges in non-statistical computational tasks and demonstrates strong applicability across diverse scenarios.
2. Minkowski Randomizer: The method optimizes the utility-privacy trade-off, significantly enhancing privacy protection strength and the accuracy of personalized computation. It maintains robust performance even when the number of users is limited.
3. Enhanced Privacy Protection: By introducing a shuffling operation, the invention increases the randomness and unpredictability of data, making it difficult for adversaries to infer individual information from input-output relationships, thereby effectively improving the overall privacy protection capability.
4. Improved Computational Efficiency: While ensuring a strong privacy guarantee, the proposed method optimizes the computation process, reduces computational complexity, and improves data processing efficiency, particularly in large-scale data processing scenarios.
5. Broad Applicability: The invention introduces a new paradigm, referred to as Private Individual Computation (PIC), which extends the shuffle model of differential privacy to support a wider class of permutation-equivariant computations beyond statistical estimation. This is of great importance, as many real-world applications require each user to obtain a personalized output rather than a single aggregated statistic, as is typical in traditional estimation tasks.

Specific applicable aspects include:
1. Machine Learning and Data Mining: PIC can generate personalized outputs while preserving privacy, which is essential for applications such as location-based social systems and federated learning with incentive mechanisms. The privacy amplification effect provided by shuffling significantly improves the utility of these applications compared to the local differential privacy (LDP) model.
2. Combinatorial Optimization: In spatial crowdsourcing and advertising allocation, PIC can match users with workers or advertisers based on users' private information while providing each party with a personalized optimal matching list. Such personalized outputs are essential for these combinatorial optimization tasks.
3. Information Retrieval: For mobile search and location-based services, PIC can generate personalized query results (e.g., nearby restaurants or neighboring users) that depend on the querier's private information while maintaining privacy protection.
4. Incentive Mechanisms: In federated learning, PIC can compute personalized incentives (e.g., monetary tokens) based on each user's contribution, such as Shapley values—a game-theoretic allocation approach—while preserving user privacy. This is crucial for encouraging trustworthy and high-quality participation.

The PIC paradigm achieves personalized outputs while maintaining privacy and benefiting from the privacy amplification effect of the shuffle model. The present invention further provides a specific protocol to implement the PIC paradigm, allowing users to receive personalized outputs without compromising anonymity, which is critical to maintaining the privacy amplification property of shuffling. It is also formally proven that PIC can handle non-statistical computational tasks. Theoretical analysis and empirical evaluation demonstrate that PIC, together with the proposed Minkowski Randomizer, achieves higher utility compared with existing solutions.

In summary, the PIC paradigm introduced in this invention substantially extends the applicability of the shuffle model of differential privacy, going beyond statistical estimation to enable a wide range of personalized computational tasks while preserving privacy and ensuring computational efficiency.

### Theoretical Validation and Experimental Support

Through comparative experiments, the proposed method demonstrates superior performance in both privacy protection strength and computational efficiency compared with existing differential privacy models. Specifically, experimental results indicate that, relative to traditional approaches, the proposed method reduces computation time by approximately 30%, while lowering the probability of privacy leakage by more than 50%. Multiple experimental evaluations confirm that the differentially private computation method based on the shuffle model proposed in this invention exhibits good stability and applicability across various data scales and application scenarios.

Comprehensive theoretical analysis and experimental results verify the effectiveness and superiority of the proposed technical solution, further enhancing its credibility and practicality in real-world applications.

In conclusion, the differential privacy computation method based on the shuffle model proposed in this invention achieves significant technological advances and improvements in addressing the long-standing challenges of privacy protection and computational efficiency in traditional differential privacy techniques. It provides new insights and technical solutions for future research and applications in privacy-preserving computation.

The core innovations of this invention include the shuffle-model-based differential privacy computation framework (PIC model) and the specially designed Minkowski Randomizer. These two technologies have distinct application scenarios and independent innovative value.

The embodiments described above are merely preferred examples of the present invention and should not be construed as limiting the scope thereof. Any modifications, equivalent substitutions, or improvements made within the spirit and principles of the present invention shall fall within the scope of its protection.

1. A differentially private computation method based on a shuffle model, comprising: constructing a personalized shuffle model; optimizing data randomization performance of the personalized shuffle model by using a randomization mechanism optimized for non-statistical tasks to obtain an improved personalized shuffle model; and using the improved personalized shuffle model to perform encryption and decryption on user input data.

2. The differentially private computation method according to claim 1, wherein constructing the personalized shuffle model comprises extending an application scope of the shuffle model to support personalized outputs rather than being limited to statistical estimation, and making the shuffle model independent of a randomizer.

3. The differentially private computation method according to claim 1, wherein optimizing the data randomization performance of the personalized shuffle model comprises configuring input and output domains of the randomization mechanism optimized for non-statistical tasks, selecting a first randomized value with a first probability and a second randomized value with a second probability using the randomization mechanism optimized for non-statistical tasks, and integrating the configured randomization mechanism optimized for non-statistical tasks into the personalized shuffle model to obtain the improved personalized shuffle model.

4. The differentially private computation method according to claim 3, wherein configuring the input and output domains of the randomization mechanism optimized for non-statistical tasks comprises defining the input and output domains as spherical, and setting a radius of the output domain to be greater than that of the input domain by a plurality of Minkowski distances.

5. The differentially private computation method according to claim 3, wherein selecting the first randomized value with the first probability and the second randomized value with the second probability comprises determining a selection range based on a true value, selecting the first randomized value within the selection range of the true value, and selecting the second randomized value outside the selection range, wherein the first probability is greater than the second probability.

6. The differentially private computation method according to claim 1, wherein using the improved personalized shuffle model to perform encryption and decryption on user input data comprises adding noise to input data by each user and encapsulating it into a public-key encrypted message under a computation server's public key, shuffling the public-key encrypted messages using the improved personalized shuffle model and transmitting the shuffled messages to the computation server, decrypting the shuffled encrypted messages and performing a permutation-equivariant computation by the computation server, outputting a result of the permutation-equivariant computation, and decrypting, by each user, an entry associated with the user's own public key from the result of the permutation-equivariant computation.

7. The differentially private computation method according to claim 6, wherein the public-key encrypted message comprises user input data, user-added noise, and a user public key.

8. The differentially private computation method according to claim 7, wherein the public key is used to enable the computation server to encrypt the results of the permutation-equivariant computation and serves as an anonymous identifier of a key owner.

9. The differentially private computation method according to claim 6, wherein shuffling the public-key encrypted messages using the improved personalized shuffle model comprises performing data permutation and message shuffling on the public-key encrypted messages using the improved personalized shuffle model and encrypting each user's input data under the computation server's public key.

10. The differentially private computation method according to claim 6, wherein outputting the results of the permutation-equivariant computation by the computation server comprises listing the results as pairs of each user's public key and the corresponding encrypted computation result.
